(19) United States
(12) Patent Application Publication
(10) Pub. No.: US 2024/0337223 A1
(43) Pub. Date: Oct. 10, 2024

(54) GLOBAL AND INDIVIDUAL CYLINDER CONTROL IN ENGINE SYSTEM

(71) Applicant: Caterpillar Inc., Peoria, IL (US)

(72) Inventors: Matthew PARKER, Washington, IL (US); Geetika DILAWARI, Dunlap, IL (US); Richard M. EDGERTON, Lula, GA (US); Bradley J. KNIER, Plainfield, IL (US); Jason PREIS, Peoria, IL (US); Amit BHOLE, Peoria, IL (US)

(73) Assignee: Caterpillar Inc., Peoria, IL (US)

(21) Appl. No.: 18/295,988

(22) Filed: Apr. 5, 2023

(51) Int. Cl. F02D 21/08; F02M 26/47

(52) U.S. Cl. CPC F02D 21/08; F02M 26/47; F02D 2021/086

(57) ABSTRACT

An engine system includes a fuel supply including a diesel fuel injector and a gaseous fuel admission valve; an engine including a cylinder configured to receive the diesel fuel and the gaseous fuel; an engine position sensor; an exhaust gas recirculation (EGR) line for adjusting an EGR flow to the cylinder; an exhaust temperature sensor; an air supply configured to supply air to the cylinder; and a controller configured to cause the engine system to adjust an air-to-fuel equivalence ratio. The adjustment is based on one or more of: a minimum air-to-fuel equivalence ratio; an exhaust temperature as compared to a target exhaust temperature; a fuel substitution; and an injection timing.

### TECHNICAL FIELD

The present disclosure relates generally to control of heat release rates and air system controls, and more particularly, to closed loop control of heat release rates and air system controls in reciprocating engines.

### BACKGROUND

Internal combustion engines are useful in a variety of different situations and in differing types of machines. For example, internal combustion engines are used to generate power for mobile machines, vehicles, and mobile or stationary power generation systems, to name a few. While some engines use only liquid fuel (e.g., either gasoline or diesel fuel), some engines are capable of operating with a gaseous fuel, either alone or in combination with a liquid fuel. Some engines, sometimes referred to as “dual fuel” engines, can operate by injecting two different types of fuel in a single combustion cycle, such as diesel fuel injected to generate a pilot flame and a gaseous fuel injected as a primary fuel. Gaseous fuel engines, including some spark-plug equipped dual fuel engines, are able to combust one or more types of gaseous fuels, including natural gas, methane, and others. Different types of gaseous fuels have different combustion characteristics, depending on the constituents that make up the fuel. The constituents of the fuel may change as a result of the source of the fuel, the time in which the fuel was processed, or manual blending of different types of gaseous fuel (e.g., natural gas blended with H2 gas). One method of quantifying the performance characteristics of a gaseous fuel is to calculate a “methane number”, which is a measure of how resistant the fuel is to detonation. While engine systems can be designed to tolerate changes in methane number, for example, these changes can significantly impact engine performance.

Additionally, operators of engine systems may desire to optimize efficiency while minimizing greenhouse gas emissions. Numerous factors can affect engine efficiency and greenhouse gas emissions including engine cylinder timing and cylinder heat release rate, air-to-fuel ratios, exhaust temperatures, dilution mass to fuel mass ratios, and other factors. In particular, it can be difficult to balance engine efficiency with emissions and other factors, especially in engines using diesel fuel and a gaseous fuel mixtures (such as, for example, diesel and propane or diesel and natural gas) because characteristics of these mixtures may be inconsistent from one fuel load to another.

U.S. Pat. No. 7,913,668, issued on Mar. 29, 2011 (“the '668 patent”), describes a method for adjusting timing of fuel injection to a boosted engine including a plurality of fuel injectors. The method includes adjusting boost during a disabled condition of a fuel injector to compensate for lack of fuel injected from the injector. However, the '668 patent is silent with respect to operating an engine system based on combustion aspects, such as, for example, an air-to-fuel equivalence ratio for minimizing greenhouse gas emissions.

The systems and methods of the present disclosure may solve one or more of the problems set forth above and/or other problems in the art. The scope of the current disclosure, however, is defined by the attached claims, and not by the ability to solve any specific problem.

### SUMMARY

In one aspect, an engine system includes a fuel supply including a diesel fuel injector and a gaseous fuel admission valve; an engine including a cylinder configured to receive the diesel fuel and the gaseous fuel; an engine position sensor; an exhaust gas recirculation (EGR) line for adjusting an EGR flow to the cylinder; an exhaust temperature sensor; an air supply configured to supply air to the cylinder; and a controller configured to cause the engine system to adjust an air-to-fuel equivalence ratio. The adjustment is based on one or more of: a minimum air-to-fuel equivalence ratio; an exhaust temperature as compared to a target exhaust temperature; a fuel substitution; and an injection timing.

In another aspect, a method of operating a reciprocating engine system, includes adjusting a diesel injection timing through a diesel fuel injector based on a heat release rate of a cylinder of the reciprocating engine system; adjusting an exhaust gas recirculation (EGR) flow to the cylinder based on a NOx level as measured in an exhaust line of the reciprocating engine system with a NOx/O2 sensor; and adjusting an air-to-fuel equivalence ratio based on one or more of: a minimum air-to-fuel equivalence ratio; an exhaust temperature as compared to a target exhaust temperature; a fuel substitution; and an injection timing.

In yet another aspect, a dual fuel engine system includes a fuel supply; an engine including a cylinder configured to receive fuel from the fuel supply; an engine position sensor; an exhaust including: an exhaust gas recirculation (EGR) line for adjusting an EGR flow to the cylinder; a NOx/O2 sensor; an exhaust temperature sensor; and an air supply configured to supply air to the cylinder; and a controller comprising a processor and one or more memories storing instructions that, when executed by the processor, cause the system to: adjust diesel injection timing to maintain a target heat release rate from each of the one or more cylinders individually based on a heat release rate of the one or more cylinders; adjust an EGR flow to the cylinders based on the NOx as measured with the NOx/O2 sensor; adjust an air-to-fuel equivalence ratio based on one or more of: a minimum air-to-fuel equivalence ratio; an exhaust temperature as compared to a target exhaust temperature; a fuel substitution; and an injection timing.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram of an engine system, according to aspects of the disclosure.

FIG. 2 is a block diagram of a controller for controlling the system of FIG. 1.

FIG. 3A is a flowchart depicting an exemplary method for controlling an engine system, according to aspects of the disclosure.

FIG. 3B is a flowchart depicting an exemplary method for controlling an engine system, according to aspects of the disclosure.

FIG. 3C is a flowchart depicting an exemplary method for controlling an engine system, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

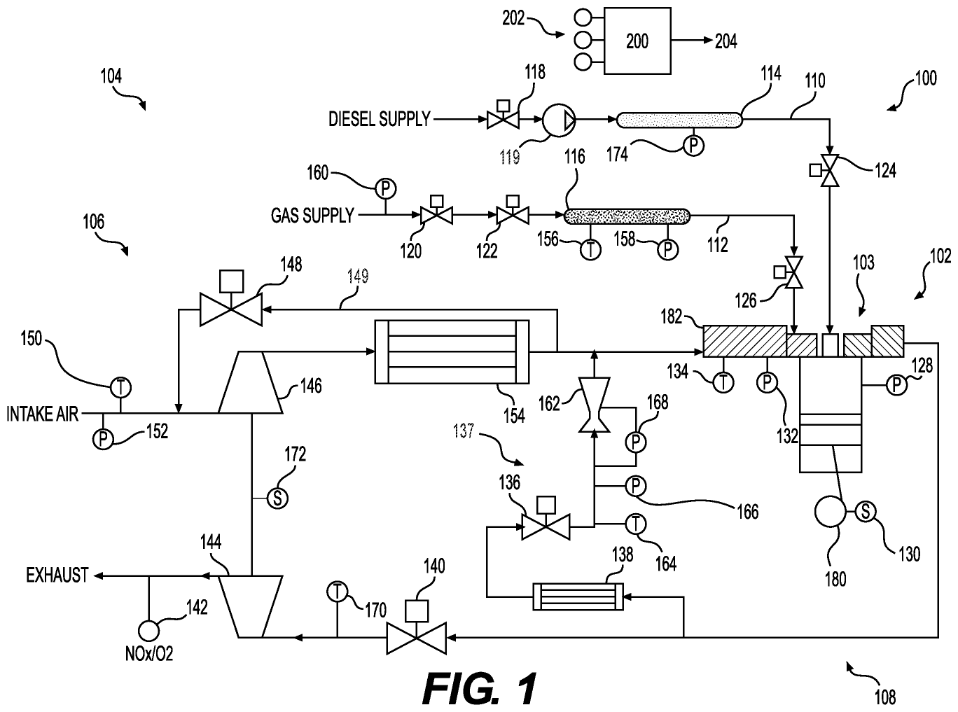

FIG. 1 illustrates a system 100 for controlling a reciprocating engine 102, which may include one or more cylinders 103 (while only one cylinder 103 is shown in FIG. 1, embodiments may include more cylinders). In addition to the engine 102, the system 100 may include a fuel supply system 104, an air supply system 106, and an exhaust system 108. The fuel supply system 104 may include a diesel supply 110 including a diesel fuel rail 114 (which may be a common fuel rail), one or more diesel fuel injectors 124, a fuel control valve 118, a fuel pump 119, and a rail pressure sensor 174. The fuel supply system 104 may further include a gas supply 112 (e.g., a natural gas, propane, or other gaseous fuel supply) including a gas shutoff valve (GSOV) 120, a gas pressure regulating valve 122, a gas fuel rail 116, a gas temperature sensor 156, a gas pressure sensor 158, and a solenoid operated gas admission valve (SOGAV) 126 or other type of injector for gaseous fuel. The gaseous fuel supply pressure may be monitored by a supply pressure sensor 160.

The engine 102 may include a crankshaft 180 and may be connected to an engine speed or position sensor 130 and an in-cylinder pressure sensor 128. The in-cylinder pressure sensor 128 may be configured to sense a cylinder pressure, which pressure may be used to determine one or more in-cylinder characteristics, such as, for example, a heat release rate (e.g., based on an in-cylinder pressure) as described in greater detail herein. An intake manifold 182 for the engine 102 may include an intake manifold absolute pressure (IMAP) sensor 132 and an intake manifold absolute temperature (IMAT) sensor 134.

The exhaust system 108 may include an exhaust gas recirculation (EGR) line 137 including an EGR cooler 138, an EGR valve 136, and an EGR venturi 162. The venturi delta pressure (e.g., a pressure drop across venturi 162) may be measured via an EGR differential pressure sensor 168. The EGR absolute pressure may be measured with an EGR absolute pressure sensor 166 and the EGR temperature may be measured with an EGR temperature sensor 164. The exhaust system 108 may further include an exhaust restrictor valve 140, a NOx/02 sensor 142, and a turbine 144. The turbine 144 may be connected to a compressor 146 of the air supply system 106 via a shaft such that a speed of the turbine/compressor combination may be measured via a turbocharger speed sensor 172. An outlet of the compressor 146 may supply compressed air to an aftercooler 154. Ambient air pressure and temperature may be measured by an ambient air temperature sensor 150 and an ambient air pressure sensor 152.

In some aspects, an air flow control device may be included in system 100 to facilitate control over a quantity of air supplied to engine 102. This air control device may facilitate adjustment of an air-to-fuel equivalence ratio, for example, by regulating a supply of air to the intake manifold 182. An exemplary air flow control device is shown in FIG. 1 as an air supply bypass valve 148 and air bypass passage 149. In the depicted example, the bypassed flow originates at bypass passage 149 downstream of the aftercooler 154 and ends at a location upstream of compressor 146, but this arrangement is not required and other arrangements are within the scope of the present application. For example, the air flow control device may include an intake throttle valve upstream of the intake manifold 182.

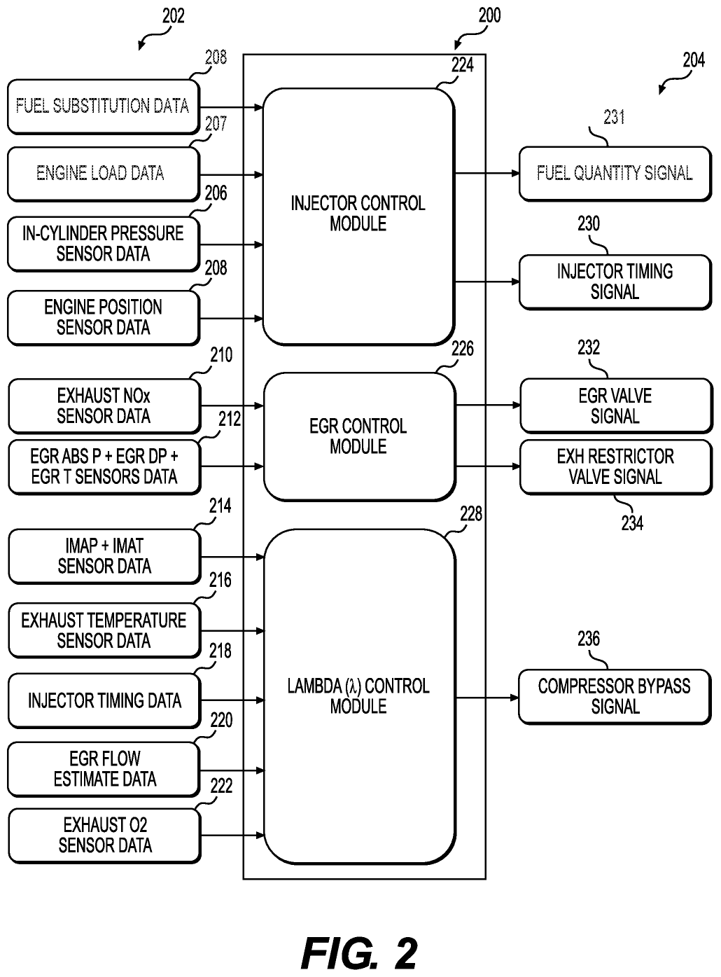

Referring now to FIG. 2, one or more components of the system 100 of FIG. 1 may be controlled by one or more modules of a controller 200. The controller 200 may be configured to receive inputs 202 and generate outputs 204. The controller 200 may be communicatively coupled to or otherwise include one or more modules or systems for carrying out one or more functions of the system 100. For example, the controller 200 may be communicatively coupled to or include an injector control module 224, an EGR control module 226, and an air-to-fuel equivalence ratio (herein referred to as “air-to-fuel equivalence ratio” or “lambda” or “2” interchangeably) control module 228. Air-to-fuel ratio is the mass ratio of air to a liquid and/or gaseous fuel present in a combustion process. If exactly enough air is provided to completely burn all of the fuel, the ratio is known as the stoichiometric air-to-fuel ratio. Adjusting the air-to-fuel ratio may retard or advance the engine timing, which can affect the heat release rate. Rich mixtures (i.e., lower than stoichiometric) may be less efficient, but may produce more power and burn cooler. Lean mixtures (i.e., higher than stoichiometric) may be more efficient but may cause higher temperatures, which can lead to the formation of nitrogen oxides. Air-to-fuel equivalence ratio (or “lambda”) is the ratio of air-to-fuel ratio to the stoichiometric air-to-fuel ratio for a given fuel mixture. Thus, a lambda value of 1.0 represents a stoichiometric air-to-fuel ratio, lambda values less than 1.0 represent relatively rich mixtures, and lambda values greater than 1.0 represent leaner mixtures. Relatively rich mixtures (i.e., lower than stoichiometric) may be less efficient, but may produce more power and burn cooler.

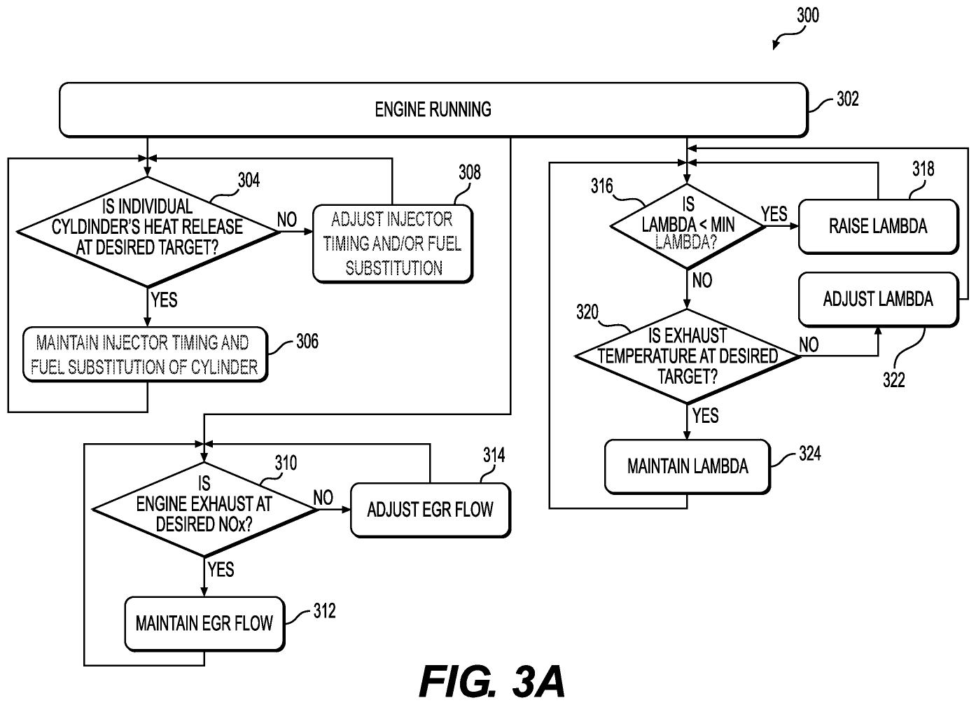

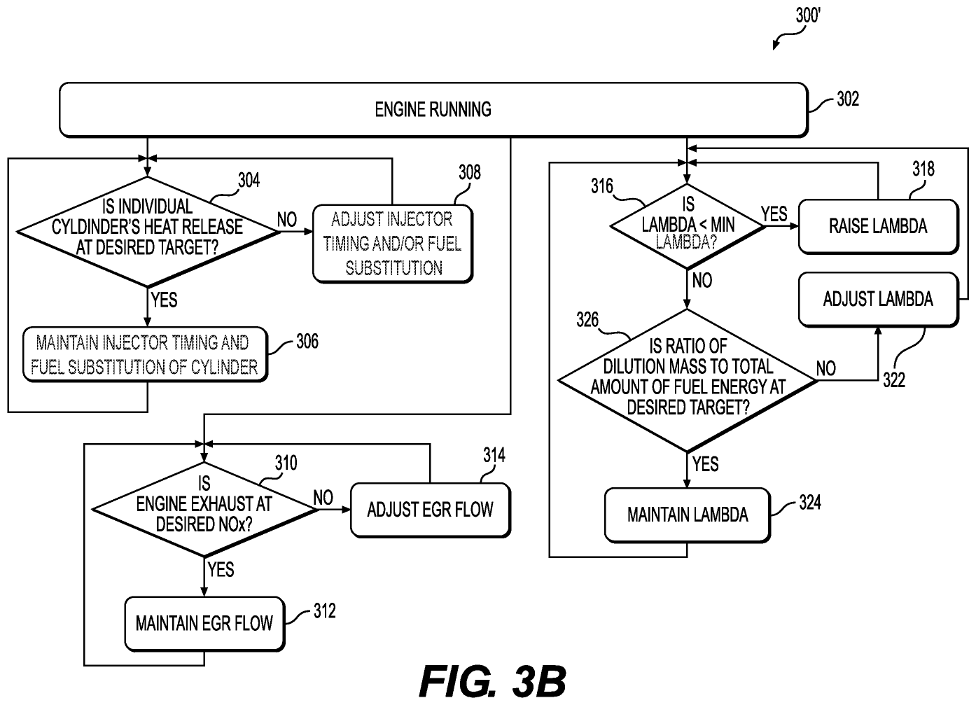

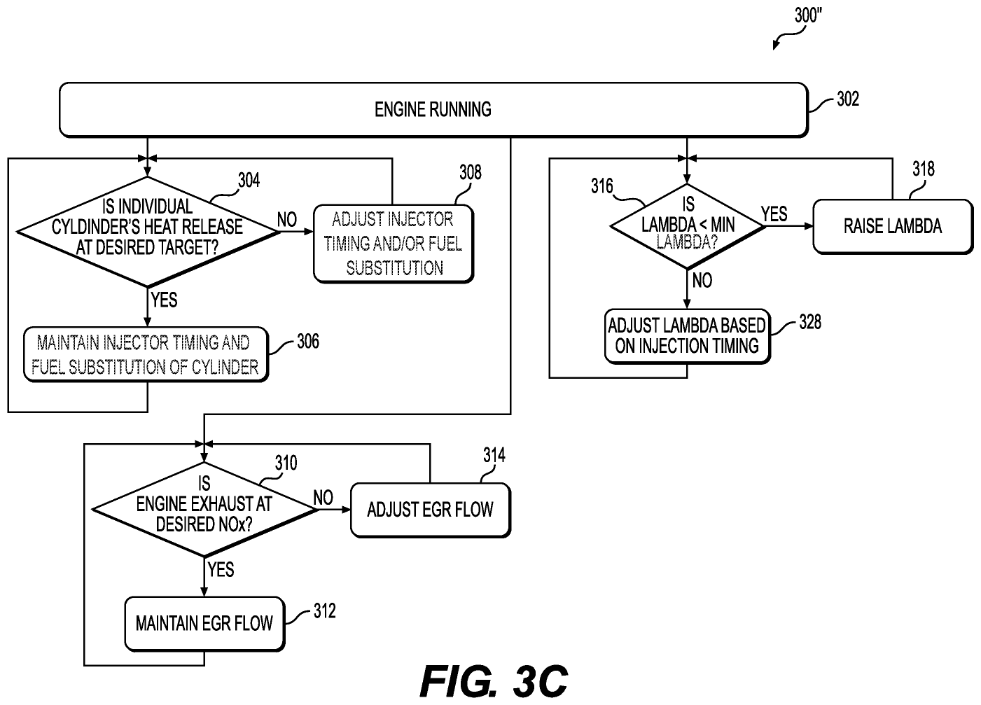

The controller 200 may include a single processor or multiple processors configured to receive inputs and generate outputs (e.g., displayed outputs and/or generated commands) to control the operation of components of the system 100. The controller 200 may include a memory, a secondary storage device, processor(s), such as central processing unit(s), networking interfaces, or any other means for accomplishing tasks consistent with the present disclosure. The memory or secondary storage device associated with controller 200 may store data, instructions, and/or software that, when executed by a processor, enable the controller 200 to perform its functions, including the functions described below with respect to methods 300, 300′, and 300″ (FIGS. 3A, 3B, 3C) and the functions of the system 100. One or more of the devices or systems communicatively coupled to the controller 200 may be communicatively coupled over a wired or wireless network, such as the Internet, a Local Area Network, WiFi, Bluetooth, or any combination of suitable networking arrangements and protocols.

Still referring to FIG. 2, inputs to the injector control module 224 may include in-cylinder pressure sensor data 206 as measured by the in-cylinder pressure sensor 128, engine position data 208 as measured by the engine position sensor 130 (which may include, for example, one or more engine speed sensors), engine load data 207, and fuel substitution data 209. Fuel substitution data 209 may correspond to a calculated value that reflects the ratio of a pilot fuel to the total fuel amount (i.e., the sum of the primary and pilot fuels), or a percentage of the pilot fuel (e.g., diesel fuel) that is replaced with the primary fuel in comparison to an engine operating solely on the pilot fuel. Thus, fuel substitution data 209 may represent the amount of pilot fuel that is effectively substituted with the primary gaseous fuel, relative to operation under pilot fuel only. Inputs to the EGR control module 226 may include exhaust NOx sensor data 210 as generated by the NOx/O2 sensor 142 and EGR system data 212 as generated by the EGR differential pressure sensor 168, the EGR absolute pressure sensor 166, and the EGR temperature sensor 164. The lambda control module 228 may receive inputs from the IMAP sensor 132 and the IMAT sensor 134 in the form of IMAP and IMAT sensor data 214, exhaust temperature data 216 from the exhaust temperature sensor 170, injector timing signal data 218 as generated by the injector control module 224 in the form of an injector timing signal 230, EGR flow estimate data 220. The EGR flow estimate data 220 may be determined, for example, based on one or more of EGR sensors 164, 166, and 168, IMAP or IMAT data from sensors 132 and 134, engine speed from sensor 130, and exhaust O2 sensor data 222 as measured by the exhaust NOx/O2 sensor 142.

As mentioned, the injector control module 224 may generate an injector timing signal 230. The injector timing signal 230 may affect the diesel fuel injector 124 and/or the SOGAV 126, causing the valves to open or close at different times to control the introduction of diesel fuel and gaseous fuel into the cylinders 103. In some embodiments, in addition to or in place of the injector timing signal 230, the controller 200 may generate a fuel quantity signal 231 for changing a quantity of injected fuel (either or both of liquid or gaseous fuel may be adjusted). As understood, signals 230 and 231 may represent commands generated to actuate the diesel fuel injector 124 and/or the SOGAV 126, and may therefore be implemented as the same signal. The EGR control module 226 may generate an EGR valve control signal 232 which may be used to control a position of the EGR valve 136. Additionally, the EGR control module 226 may generate an exhaust restrictor valve control signal 234 which may control a position of the exhaust restrictor valve 140, and the lambda control module 228 may generate a compressor bypass signal 236 which may control the bypass valve 148 for controlling an air-to-fuel equivalence ratio.

### INDUSTRIAL APPLICABILITY

The disclosed aspects of the system 100 of the present disclosure may be used to dynamically adjust the diesel injection and/or the gaseous fuel injection timing. The diesel injection timing and/or the gaseous fuel injection timing may be adjusted on both a per cylinder basis based on the heat release rate of each cylinder and on a global basis based on lambda to each of the cylinders and the global EGR flow. The diesel injection timing may be adjusted independently for each of the one or more cylinders 103 such that closed loop control of the heat release rate (HRR) is achieved. In some embodiments, the HRR may be measured indirectly by measuring a pressure in each of the one or more cylinders 103 (e.g., via in-cylinder pressure sensor 128). Global EGR flow (i.e., flow to all of the cylinders) may be adjusted through closed loop control according to the amount of NOx produced by the one or more cylinders 103 as determined by the NOx/O2 sensor 142. In some embodiments, fuels may have various methane numbers, which may change from fuel to fuel based on, for example, the particular fuel blend and/or the type of gaseous fuel that is used. As the methane number decreases, detonation and HRR will generally advance. On the other hand, if the fuel has a higher methane number than expected, heat release will tend to occur later than expected.

Based on methane number, diesel injection timing may advance to maintain a particular HRR within the cylinders 103. As diesel injection timing advances, the system 100 may increase an EGR flow (e.g., by opening the EGR valve 136) to maintain the NOx level as measured at the NOx/O2 sensor 142. In some embodiments, there may be a single target EGR flow and the target EGR flow may be adjusted globally for all of the cylinders of the engine simultaneously (e.g., to the target EGR flow). Meanwhile, the air-to-fuel equivalence ratio (or “lambda”) can be controlled using various techniques as described herein below.

Referring to FIG. 3A, a method 300 of operating the engine system 100 of FIGS. 1 and 2 is shown. At step 302, an operator may commence running the engine system 100. For example, the engine system 100 may be started using an ignition. The engine system 100 may include one or more of the aspects described above with respect to FIGS. 1 and 2. Once started, the dual fuel engine 102 may be operated based on optimizing power generation, increasing fuel efficiency, and reducing emissions of greenhouse gases such as NOx.

At step 304, it may be determined whether an individual cylinder 103 combusts fuel in a manner that generates heat at a desired or target HRR. The individual cylinder's actual HRR may be determined based on in-cylinder pressure as read by the in-cylinder pressure sensor 128 and the engine position and/or speed as read by the engine position sensor 130. The HRR may be compared to a target HRR that is stored, for example, in a lookup table in a memory (e.g., in the controller 200) or in another aspect of the system 100.

If the individual cylinder's actual HRR has a value equal to that of the target HRR, the controller 200 may maintain the injector timing of the cylinder at step 306. However, if the HRR is not at the desired level represented by the target HRR, the controller 200 may adjust the injector timing and/or the fuel substitution for each cylinder 103 individually at step 308. The controller 200 may change the injector timing using, for example, the injector control module 224, which may generate an injector timing signal 230 for diesel fuel injector 124 and/or for adjusting a timing of the SOGAV 126. The controller 200 may adjust the fuel substitution by generating a fuel quantity signal 231. The injector timing signal 230 may advance the injector timing for HRRs which are delayed and may retard the injector timing for HRRs which are advanced in order to achieve the target HRR in a given cylinder. In some embodiments, if the timing adjustment exceeds a maximum threshold, a quantity of injected gas may also be adjusted. For example, if timing is advanced, the fuel substitution may be adjusted to add more diesel fuel and less gaseous fuel and if the timing is retarded, the fuel substitution may be adjusted to add less diesel fuel and more gaseous fuel. This process may be performed for each cylinder on a cylinder-by-cylinder basis, as opposed to a “global” adjustment, for example. As used herein, the terms “per cylinder” or “cylinder-by-cylinder basis” refer to a capability to control or adjust a characteristic, threshold, or setpoint for an individual cylinder differently than one or more other cylinders of the same engine. Whereas, a global adjustment refers to adjusting a characteristic, threshold, or setpoint for each of the cylinders to a common value.

At step 310, EGR control module 226 may determine whether engine exhaust is at a desired NOx level using, for example, the NOx/O2 sensor 142. The measured NOx/02 level may be compared to a target NOx/02 level (e.g., a predetermined maximum threshold value). The target NOx/02 level may be stored, for example, in a lookup table in a memory (e.g., in the controller 200) or in another aspect of the system 100. If NOx/02 level is satisfactory, the EGR control module 226 may maintain an EGR flow at its current level at step 312. However, if the engine exhaust does not contain a desired NOx/02 level (e.g., the measured NOx is greater than the predetermined maximum threshold), the EGR control module 226 may adjust EGR flow at step 314. The EGR control module 226 may adjust EGR flow on a global basis, such that each of the one or more cylinders receives essentially the same level of EGR flow. To adjust the EGR flow, the EGR control module 226 may generate an EGR valve control signal 232 to control the EGR valve 136 and/or an exhaust restrictor valve control signal 234 to adjust the exhaust restrictor valve 140. The system 100 may open the EGR valve 136 to increase EGR flow and may close the exhaust restrictor valve 140 to increase EGR flow.

At step 316, lambda control module 228 may determine whether the air-to-fuel equivalence ratio of the air and fuel injected to the one or more cylinders 103 is less than a minimum air-to-fuel equivalence ratio. The air-to-fuel equivalence ratio may be determined based on, for example, signals input from one or more of the IMAP sensor 132, the IMAT sensor 134, an EGR flow estimate as determined based on the positions of the EGR valve 136 and the exhaust restrictor valve 140, and the NOx/O2 sensor 142. The determined air-to-fuel ratio may be compared to, for example, a minimum air-to-fuel equivalence ratio which may be a threshold value retrieved from a lookup table stored in memory (e.g., in the controller 200) or in another aspect of the system 100.

If the determined lambda is less than the minimum lambda, the system 100 may increase the air-to-fuel equivalence ratio at step 318. The system 100 may increase the lambda by controlling the air supply bypass valve 148, for example, or another type of air flow control device, to supply an increased amount of air to engine 102. For example, the system 100 may close the bypass valve 148 such that less air is returned from the output of the compressor 146 to its inlet increasing the amount of air that makes its way to the intake manifold 182 increasing the quantity air per quantity fuel in the one or more cylinders 103.

If at step 316, lambda control module 228 determines that the air-to-fuel equivalence ratio exceeds the minimum threshold, controller 200 may further determine whether the exhaust temperature is at a desired target exhaust temperature at step 320. If the exhaust temperature is at the desired target exhaust temperature at step 320, then the lambda control module 228 may maintain lambda at step 324 (i.e., it may not adjust a setting of the bypass valve 148 or other flow control device). If however, it is determined that the exhaust temperature is not at the desired target, the system may adjust lambda at step 322 by altering a position of the bypass valve 148. The system 100 may open the bypass valve 148 to decrease lambda and may shut the bypass valve 148 to increase the air-to-fuel equivalence ratio. Increasing lambda may generally decrease the exhaust temperature and vice-versa.

Referring now to FIG. 3B, another method 300′ of operating the engine system 100 of FIGS. 1 and 2 is shown. The method 300′ includes similar steps as method 300 with respect to maintaining the system based on individual cylinder's HRRs (i.e., steps 302-308) and a global threshold for engine exhaust NOx level (i.e., steps 302 and 310-314). However, the method 300′ includes a different methodology for maintaining an air-to-fuel equivalence ratio.

In method 300′, similarly to method 300, at step 316 it may be determined whether the air-to-fuel equivalence ratio of the air and fuel injected to the one or more cylinders 103 is less than a minimum air-to-fuel equivalence ratio. Step 316 of method 300′ may be performed as described above with respect to method 300.

However, in method 300′, if it is determined that lambda is not less than a minimum lambda, the system 100 may determine whether a ratio of dilution mass (i.e., the total amount of air flow and EGR flow-hence, the total amount of mass entering the cylinders which is not fuel mass from the fuel supply) to total amount of fuel energy is at a desired target at step 326.

If the ratio of dilution mass to total amount of fuel mass is at the desired target, the lambda control module 228 may maintain lambda at step 324 and the EGR valve 136 and the bypass valve 148 may remain in their current positions. However, if the ratio of dilution mass to total amount of mass is not at the desired target, the lambda control module 228 may adjust lambda at step 322. For example, one or more of the EGR valve 136 and the bypass valve 148 may be opened or shut to adjust the air-to-fuel equivalence ratio, as described above.

Referring now to FIG. 3C, another method 300″ of operating the engine system 100 of FIGS. 1 and 2 is shown. The method 300″ includes similar steps as methods 300 and 300′ with respect to maintaining the system based on individual cylinder's HRRs (i.e., steps 302-308) and a global threshold for engine exhaust NOx level (i.e., steps 302 and 310-314). However, the method 300″ includes a different methodology for maintaining an air-to-fuel equivalence ratio.

As shown in FIG. 3C, at step 316 it may be determined whether the air-to-fuel equivalence ratio of the air and fuel injected to the one or more cylinders 103 is less than a minimum air-to-fuel equivalence ratio. This may be performed as described above. If the determined lambda is less than the minimum lambda, the system 100 may increase the lambda at step 318, as described above. The lambda may be determined based on, for example, input from one or more of the IMAP sensor 132, the IMAT sensor 134, the exhaust temperature sensor 170, the injector timing signal data 218, an EGR flow estimate as determined based on the positions of the EGR valve 136 and the exhaust restrictor valve 140, and the NOx/O2 sensor 142. The determined lambda may be compared to, for example, a minimum lambda, which minimum lambda may be stored in a lookup table in a memory (e.g., in the controller 200) or in another aspect of the system 100.

If the determined lambda is less than a minimum lambda, the system 100 may increase the air-to-fuel equivalence ratio at step 318. The system 100 may increase the air-to-fuel equivalence ratio by controlling the air supply bypass valve 148. For example, the system 100 may close the bypass valve 148 such that less air is returned from the output of the compressor 146 to its inlet increasing the amount of air that makes its way to the intake manifold 182 increasing the quantity air per quantity fuel in the one or more cylinders 103.

If the determined lambda is not below the minimum lambda, the system 100 may adjust the air-to-fuel equivalence ratio based on injection timing at step 328. With brief reference to FIG. 2, the injector timing signal data 218 may serve as an input to the lambda control module 228. This data may be used to adjust the air supply bypass valve 148 with the compressor bypass signal 236. The engine system 100 may adjust the injection timing via the injector timing signal data 218 to optimize the air-to-fuel equivalence ratio based on a cylinder heat release rate, greenhouse gas emissions and exhaust temperatures. In some embodiments, control of the air-to-fuel equivalence ratio may serve as a feed forward control of the system 100 for faster system response.

Referring to FIGS. 3A, 3B, and 3C, the system 100 may weigh the various factors described hereinabove appropriately with respect to controlling the air-to-fuel equivalence ratio to optimize efficiency and minimize the emissions of greenhouse gases. For example, the individual control of cylinder heat release rate may be the dominant factor in some systems or at some times, while the NOx levels in the exhaust system and the air-to-fuel equivalence ratio may be subordinate factors. In other embodiments, the desired NOx level or the air-to-fuel equivalence ratio may be the dominant factor(s) at least some of the time. In some embodiments, adjustment to the air-to-fuel equivalence ratio as a function of injection timing as described above may serve as a feed-forward control, which may provide faster response. Other adjustments to system operation, such as adjustments based on exhaust temperature, may serve as feedback system control. Simultaneously, the minimum lambda levels controlled by the system will prohibit the engine system 100 from emitting unacceptable particulate matter emissions.

The disclosed system and methods may increase efficiency and lower greenhouse gas emissions in reciprocating engines. Aspects of the system and methods, including adjusting a diesel injection timing individually based on a heat release rate of one or more cylinders; adjusting an EGR flow to the one or more cylinders individually and adjusting an lambda can be particularly beneficial for reciprocating engines using a dual fuel arrangement with a diesel fuel and gaseous fuel, such as propane or natural gas. Incorporation of the aspects described herein may give particular advantages to reciprocating engines, for example, aspects described herein may maximize engine performance across a range of gaseous fuel reactivity while minimizing methane slip.

It will be apparent to those skilled in the art that various modifications and variations can be made to the disclosed system without departing from the scope of the disclosure. For example, each of the steps of the methods described hereinabove can be performed in any order and in any combination to control the heat release, greenhouse gas emissions, and exhaust temperatures of the engine system described herein. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

1. An engine system comprising:
a fuel supply including a pilot fuel injector and a gaseous fuel admission valve;
an engine including a cylinder configured to receive the pilot fuel and the gaseous fuel;
an engine position sensor;
an exhaust gas recirculation (EGR) line for adjusting an EGR flow to the cylinder;
an exhaust temperature sensor;
an air supply configured to supply air to the cylinder; and
a controller configured to cause the engine system to adjust an air-to-fuel equivalence ratio based on one or more of:
an exhaust temperature as compared to a target exhaust temperature, wherein if the exhaust temperature is less than the target exhaust temperature, the controller is further configured to generate commands that cause the air-to-fuel equivalence ratio of the engine to decrease and the exhaust temperature of the engine to increase;
a fuel dilution; or
an injection timing.

2. The engine system of claim 1, wherein the cylinder includes a pressure sensor configured to measure cylinder pressure, the controller being further configured to determine a heat release rate for the cylinder from the measured cylinder pressure.

3. The engine system of claim 1, wherein the EGR line includes an EGR valve, an EGR pressure sensor, an EGR temperature sensor, and an EGR differential pressure sensor and the EGR flow is measured based on input from one or more of the EGR pressure sensor, the EGR temperature sensor, and the EGR differential pressure sensor.

4. The engine system of claim 1, wherein the engine further includes an intake manifold including an intake manifold pressure sensor and an intake manifold temperature sensor and the air-to-fuel equivalence ratio is controlled based on input from the intake manifold pressure sensor and the intake manifold temperature sensors.

5. The engine system of claim 4, wherein the air supply further includes an air flow control device for adjusting the air-to-fuel equivalence ratio by regulating a supply of air to the intake manifold.

6. The engine system of claim 1, further comprising:
a NOx/O2 sensor, and
wherein the controller is further configured to cause the engine system to:
adjust an EGR flow to the cylinders based on NOx as measured with the NOx/O2 sensor.

7. The engine system of claim 1, further comprising:
a plurality of fuel injectors configured to inject pilot fuel into a plurality of cylinders, and
wherein the controller is further configured to cause the engine system to:
adjust pilot fuel injection timing with the fuel injectors to maintain a target heat release rate from each of a plurality of cylinders on an individual basis, based on a heat release rate of each of the cylinders.

8. The engine system of claim 7, wherein each of the plurality of cylinders includes a pressure sensor configured to measure cylinder pressure.

9. The engine system of claim 8, wherein the air-to-fuel equivalence is globally controlled to each of the plurality of cylinders.

10. The engine system of claim 9, wherein the controller adjusts the air-to-fuel equivalence ratio based on at least two of:
the exhaust temperature as compared to the target exhaust temperature;
the fuel dilution; or
the injection timing.

11. A method of operating a reciprocating engine system, comprising:
adjusting a pilot fuel injection timing through a fuel injector based on a heat release rate of a cylinder of the reciprocating engine system;
adjusting an exhaust gas recirculation (EGR) flow to the cylinder based on a NOx level as measured in an exhaust line of the reciprocating engine system with a NOx/O2 sensor; and
adjusting an air-to-fuel equivalence ratio based on one or more of:
a fuel dilution; or
the pilot fuel injection timing.

12. The method of claim 11, wherein the cylinder includes a pressure sensor configured to measure cylinder pressure and the heat release rate of the cylinder is determined from the measured cylinder pressure.

13. The method of claim 11, wherein the EGR flow is provided from an EGR line that includes an EGR valve, an EGR pressure sensor, an EGR temperature sensor, and an EGR differential pressure sensor and the EGR flow is measured based on input from one or more of the EGR pressure sensor, the EGR temperature sensor, and the EGR differential pressure sensor.

14. The method of claim 11, wherein the pilot fuel injection timing is advanced based on a methane number of a gaseous fuel supplied to the reciprocating engine system.

15. The method of claim 14, wherein the reciprocating engine system includes a plurality of cylinders, each of the cylinders configured to receive diesel fuel from the fuel injector, the diesel fuel forms the pilot fuel, and the pilot fuel injection timing is further adjusted to maintain a target heat release rate for each of the plurality of cylinders on an individual basis.

16. The method of claim 15, wherein the EGR flow to each of the plurality of cylinders is globally controlled such that the EGR flow is adjusted to a single target EGR flow for all of the cylinders.

17. The method of claim 14, wherein the air-to-fuel equivalence ratio of fuel injected to a plurality of cylinders is globally controlled to all of the cylinders.

18. The method of claim 11, wherein pilot injection timing is adjusted for a plurality of cylinders simultaneously.

19. A dual fuel engine system comprising:
a fuel supply;
an engine including one or more cylinders configured to receive fuel from the fuel supply;
an engine position sensor;
an exhaust including:
an exhaust gas recirculation (EGR) line for adjusting an EGR flow to the one or more cylinders;
a NOx/O2 sensor;
an exhaust temperature sensor; and
an air supply configured to supply air to the one or more cylinders; and
a controller comprising a processor and one or more memories storing instructions that, when executed by the processor, cause the system to:
adjust pilot fuel injection timing to maintain a target heat release rate from each of the one or more cylinders individually based on a heat release rate of the one or more cylinders;
adjust an EGR flow to the one or more cylinders based on NOx measured with the NOx/O2 sensor;
adjust an air-to-fuel equivalence ratio based on one or more of:
a fuel dilution; or
the pilot fuel injection timing.

20. The dual fuel engine system of claim 19, wherein the fuel supply includes a diesel fuel injector and a solenoid operated gas admission valve.
